(19) United States
(12) Patent Application Publication
(10) Pub. No.: US 2026/0359991 A1
(43) Pub. Date: Nov. 12, 2026

(54) Deep Video AI Action Zoom for High-Speed Motion Accuracy

(71) Applicant: Kevin Ashley, San Juan Capistrano, CA (US)

(72) Inventor: Kevin Ashley, San Juan Capistrano, CA (US)

(21) Appl. No.: 19/199,683

(22) Filed: May 6, 2025

(51) Int. Cl. G06T 7/20; G06T 3/40; G06T 5/73; G06V 10/25; H04N 7/01

(52) U.S. Cl. CPC G06T 7/20; G06T 3/40; G06T 5/73; G06V 10/25; H04N 7/013; G06T 2207/20084

(57) ABSTRACT

The present invention, Deep AI Video Action Zoom for High-Speed Motion Accuracy, enhances motion detection in high-speed video sequences using artificial intelligence. Traditional video AI models struggle with precision when analyzing fast-moving objects, impacting applications such as sports analysis, autonomous navigation, surveillance, and augmented reality. This invention integrates deep learning models, adaptive AI action zoom technology, and predictive neural networks to refine motion detection accuracy. A Video Properties Detector analyzes motion characteristics, while a Deep Video AI Framework improves tracking precision. The Adaptive Action Zoom Module dynamically enhances focal areas, and contextual predictive modeling ensures real-time motion refinement. By applying advanced AI-driven video insights and enhancement algorithms, this system significantly improves accuracy, enabling precise action tracking, optimized video insights, and adaptive action video zoom functionality across industries requiring high-speed video analysis.

### BACKGROUND OF THE INVENTION

This invention relates to artificial intelligence (AI) and computer vision technologies used for high-accuracy video processing in action scenes, such as sports or high-frequency action. Specifically, it pertains to the improvement of AI-driven video motion detection accuracy, enabling more precise action detection in fast-moving visual environments.

### SUMMARY OF THE INVENTION

The present invention relates to advanced artificial intelligence (AI) models designed to improve motion detection accuracy in high-speed video sequences with AI models, such as Large Language Models (LLMs). Traditional video processing models often struggle with accuracy, and loss of detail when analyzing fast-moving objects. These challenges impact applications such as sports analysis, autonomous vehicle navigation, surveillance, and augmented reality (AR).

The invention introduces Deep AI Video Action Zoom, a cutting-edge framework that integrates deep learning techniques with video motion improvement algorithms to enhance AI models video understanding. Utilizing a combination of video modification and AI models prompting, the system accurately identifies and tracks high-frequency movements while dynamically adjusting output for optimized clarity.

Key features of this invention include:
AI driven video insights that provide an estimate of the video content.
Video enhancement algorithms that refine high-speed footage.
Adaptive AI action zoom technology powered by deep learning for precision-based scaling.
Neural network-based predictive modeling to maintain image sharpness during rapid motion sequences. By leveraging a combination of state-of-the-art algorithms and AI models, this invention significantly advances the field of motion-focused video analysis, providing unparalleled accuracy and clarity in high-speed applications.

### BRIEF DESCRIPTION OF DRAWINGS

FIG. 1 is a block diagram illustrating the overall architecture of the Deep AI Video Action Zoom system, including the input video, INITIAL video processing unit including video properties detector, initial video insights, and DEEP ZOOM AI processing unit, with deep video AI framework, AI model, output zoom video and output accuracy enhanced video insights.

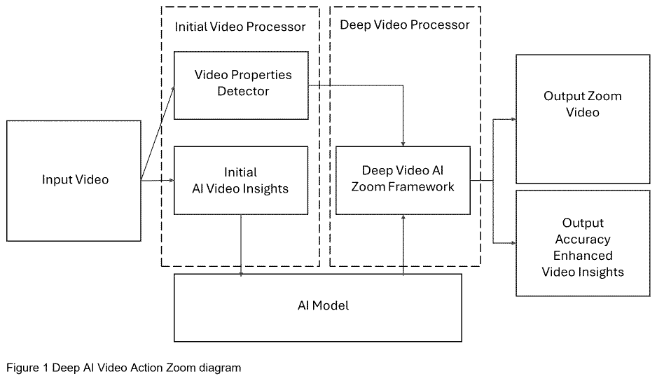

### DETAILED DESCRIPTION OF THE INVENTION

The Deep AI Video Action Zoom for High-Speed Motion Accuracy system is a revolutionary advancement in AI-driven video processing, designed to enhance the accuracy of motion detection in fast-moving environments. The invention addresses key limitations in traditional video models by integrating AI modelling algorithms, video enhancement techniques, and adaptive AI action zoom mechanisms to provide unparalleled accuracy in tracking and understanding rapid motion sequences.

System Architecture & Functionality-The invention consists of a multi-layered processing framework, encompassing the following components:

Video Input and Initial Processing Unit-The system receives raw video input, capturing high-speed sequences from various sources, such as sports events, autonomous driving footage, or security surveillance recordings. The Video Properties Detector analyzes frame rate (fps), resolution, and motion intensity, as well as contextual nature of the video, producing Initial Video Insights that serve as foundational data for subsequent processing.

Deep AI Processing Unit—This core module implements AI models to refine motion detection accuracy, combined with dynamically enhanced prompting to improve the output accuracy. The Deep Video AI Framework integrates neural networks such as large language models, not necessarily trained on high-frequency motion data, and the video enhanced by the Video Input and Processing unit above, allowing precise identification of dynamic movements. The AI model actively enhances video insights accuracy.

Adaptive Action Zoom Technology—Using deep learning principles, the system dynamically adjusts action accuracy levels based on detected motion patterns. This adaptive zoom mechanism allows targeted analysis of critical events within the video, such as a fast sprint in a sports competition, sport action such as surfing maneuvers, figure skating jumps, boxing punches, or a sudden maneuver in autonomous driving footage.

Neural Network—Based Contextual Action Predictive Analysis-To further enhance motion clarity, the system employs predictive contextual action modeling to anticipate the required enhancement action zoom parameters.

Output Enhancement & Final Video Insights—Once processing is completed, the system generates Output Zoom Video files with optimized motion accuracy. The final step involves producing Enhanced Video Insights, which summarize the detected actions, provides deep insights into key moments of the video, and detailed action insights throughout the sequence.

Applications & Benefits—The Deep AI Video Action Zoom technology significantly improves high-speed video analysis across various industries:

Sports Analysis: Enables precise tracking of athletes' movements, facilitating performance evaluations in real-time.

Autonomous Vehicle Navigation: Enhances object recognition in fast-moving environments, improving self-driving system reliability.

Surveillance & Security: Provides sharper motion detection for security footage, ensuring accurate identification of critical events.

Augmented Reality (AR) & Virtual Reality (VR): Refines movement tracking in immersive experiences, enhancing user interaction with digital environments.

By leveraging deep learning, neural networks, and adaptive motion processing, this invention sets a new standard for AI-driven video accuracy, offering unprecedented clarity and precision in high-speed applications.

1. A method for improving high-speed motion detection accuracy in video sequences using artificial intelligence, the method comprising:
Receiving an input video containing high-speed motion sequences;
Processing said video using a Video Properties Detector to analyze frame rate, resolution, motion intensity, and contextual element;
Generating Initial Video Insights based on detected properties;
Utilizing a Deep Video AI Framework to refine motion detection accuracy through deep learning algorithms;
Implementing adaptive AI action zoom technology to enhance specific motion areas within the video sequence;
Applying neural network-based predictive modeling to maintain accuracy during rapid motion sequences;
Producing Output Zoom Video with improved motion clarity and Enhanced Video Insights summarizing detected actions.

2. The method of claim 1, wherein the Video Properties Detector is configured to recognize variations in motion patterns, image quality degradation due to rapid movement, and environmental conditions affecting the video insights accuracy.

3. The method of claim 1, wherein the Deep Video AI Framework comprises:
A neural network trained to differentiate high-frequency motion sequences;
An AI-driven video enhancement algorithm that applies adaptive sharpening techniques;
A video modification and AI model prompting system that dynamically adjusts video frames for optimal accuracy.

4. The method of claim 1, wherein the adaptive AI action zoom technology autonomously adjusts frame rate and video parameters based on detected movement patterns, enabling enhanced visibility of fast-moving objects.

5. The method of claim 1, wherein the neural network-based predictive modeling utilizes contextual action analysis to anticipate necessary zoom enhancements, ensuring continuity and precision in motion tracking.

6. A system for AI-driven enhancement of high-speed motion detection accuracy in video sequences, the system comprising:
A Video Input Unit configured to process raw video from various high-motion environments;
A Deep AI Processing Unit incorporating AI-driven accuracy models;
An Adaptive Action Zoom Module for dynamic motion tracking;
A Predictive Motion Analysis Unit utilizing neural networks for contextual action anticipation;
An Output Enhancement Unit that generates optimized video insights with improved motion accuracy.

7. The system of claim 6, wherein the Deep AI Processing Unit utilizes large language models (LLMs) integrated with deep learning frameworks to improve action detection performance.

8. The system of claim 6, wherein the Adaptive Action Zoom Module selectively enhances specific regions of interest within a video sequence to improve visibility and motion clarity.

9. The system of claim 6, wherein the Predictive Motion Analysis Unit dynamically adjusts the AI prompting process based on high-frequency action patterns detected in the input video.
